(19) United States
(12) Patent Application Publication
(10) Pub. No.: US 2023/0065626 A1
(43) Pub. Date: Mar. 2, 2023

(54) IMAGE FORMING SYSTEM AND IMAGE FORMING METHOD CAPABLE OF SHARING IMAGE FORMING JOBS AMONG PLURALITY OF IMAGE FORMING APPARATUSES

(71) Applicant: KYOCERA Document Solutions Inc., Osaka (JP)

(72) Inventor: Koji Ikawa, Osaka (JP)

(21) Appl. No.: 17/821,698

(22) Filed: Aug. 23, 2022

(30) Foreign Application Priority Data
Aug. 24, 2021 (JP) 2021-136247

(51) Int. Cl. G06F 3/12

(52) U.S. Cl. CPC G06F 3/1212; G06F 3/1224; G06F 3/1263

(57) ABSTRACT

Provided is an image forming system including a determination processing portion and a sharing control portion. The determination processing portion determines share rates of an image forming job for each of a plurality of image forming apparatuses based on a startable timing at which a new job can be started by each of the plurality of image forming apparatuses. The sharing control portion causes the plurality of image forming apparatuses to share the image forming job based on the share rates of the image forming job determined in the determination processing portion.

### INCORPORATION BY REFERENCE

This application is based upon and claims the benefit of priority from the corresponding Japanese Patent Application No. 2021-136247 filed on Aug. 24, 2021, the entire contents of which are incorporated herein by reference.

### BACKGROUND

The present disclosure relates to an image forming system and image forming method executed by the image forming system.

Image forming systems that include a plurality of image forming apparatuses and a server are known. In this kind of image forming system, an image forming job input to a server is executed by any of the image forming apparatuses selected by the server.

### SUMMARY

The image forming system according to one aspect of the present disclosure includes a determination processing portion and a sharing control portion. The determination processing portion determines share rates of an image forming job for each of a plurality of image forming apparatuses based on a startable timing at which a new job can be started by each of the plurality of image forming apparatuses. The sharing control portion causes the plurality of image forming apparatuses to share the image forming job based on the share rates of the image forming job determined by the determination processing portion.

The image forming method according to another aspect of the present disclosure includes a determination step and a sharing control step that are executed by an image forming system. In the determination step, share rates of an image forming job for each of a plurality of image forming apparatuses are determined based on a startable timing at which a new job can be started by each of the plurality of image forming apparatuses. In the sharing control step, the image forming job is shared by the plurality of image forming apparatuses based on the share rates of the image forming job determined in the determination step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming system of an embodiment according to the present disclosure.

FIG. 2 is a diagram showing a configuration of a printing device included in an image forming system of an embodiment according to the present disclosure.

FIG. 3 is a diagram showing a configuration of a client terminal included in an image forming system of an embodiment according to the present disclosure.

FIG. 4 is a diagram showing a configuration of a printing server included in an image forming system of an embodiment according to the present disclosure.

FIG. 5 is a table showing an example of schedule data used by an image forming system of an embodiment according to the present disclosure.

FIG. 6 is a table showing an example of schedule data used by an image forming system of an embodiment according to the present disclosure.

FIG. 7 is a table showing an example of schedule data used by an image forming system of an embodiment according to the present disclosure.

FIG. 8 is a flowchart showing an example of a sharing control process executed by an image forming system of an embodiment according to the present disclosure.

### DETAILED DESCRIPTION

Embodiments according to the present disclosure will be described below with reference to the accompanying drawings. Note that the following embodiments are examples of implementing techniques according to the present disclosure and do not limit the technical scope of the present disclosure.

[Image Forming System 100]

An image forming system 100 of an embodiment according to the present disclosure executes a printing job for printing target printing data.

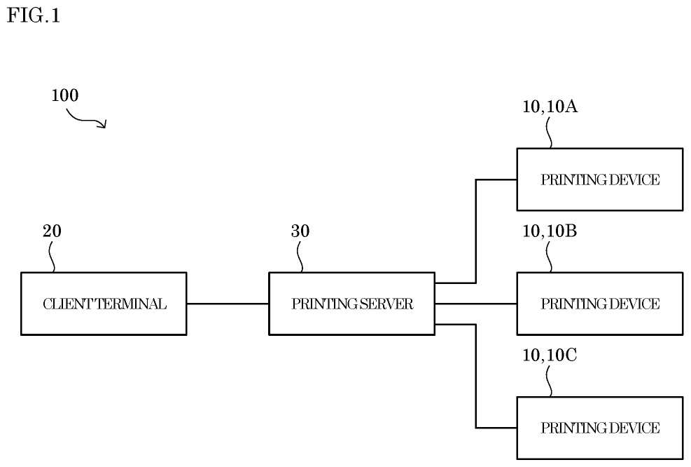

As shown in FIG. 1, the image forming system 100 includes a plurality of printing devices 10, a client terminal 20, and a printing server 30. In the image forming system 100, the client terminal 20 and the printing server 30 are connected to each other via a communication network so as to be able to communicate with each other. For example, the communication network is the Internet or a Local Area Network (LAN). In addition, in the image forming system 100, the printing server 30 and the printing devices 10 are connected to each other via the communication network so as to be able to communicate with each other. The number of printing devices 10 included in the image forming system 100 is not limited to three (see FIG. 1), and may be two or four or more.

[Printing Device 10]

A printing device 10 is used to execute the printing job. For example, the printing device 10 is a multifunction peripheral having a plurality of functions such as a scanning function for reading an image of an original document, a printing function for forming an image based on image data, a fax function, a copying function, and the like. The printing device 10 is an example of the image forming apparatus of the present disclosure. The image forming apparatus according to the present disclosure may be a printer, a fax machine, a copier, or the like.

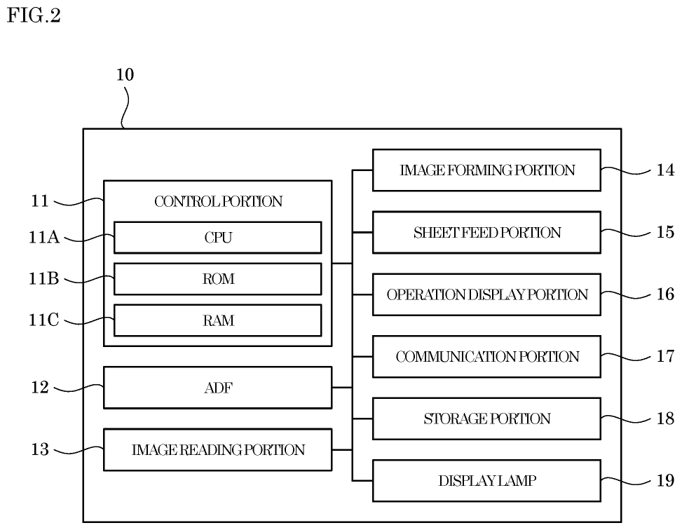

As shown in FIG. 2, the printing device 10 includes a control portion 11, an ADF 12, an image reading portion 13, an image forming portion 14, a sheet feed portion 15, an operation display portion 16, a communication portion 17, a storage portion 18, and a display lamp 19.

The control portion 11 performs overall control of the printing device 10. As shown in FIG. 2, the control portion 11 includes a CPU 11A, a ROM 11B, and a RAM 11C. The CPU 11A is a processor that executes various types of arithmetic processes. The ROM 11B is a non-volatile storage device in which information such as a control program for causing the CPU 11A to execute various types of processes is stored in advance. The RAM 11C is a volatile or non-volatile storage device used as a temporary storage memory (work area) for various types of processes executed by the CPU 11A. The CPU 11A executes various types of control programs stored in advance in the ROM 11B. Thus, overall control of the printing device 10 is performed.

The ADF 12 conveys a document sheet whose image is to be read by the image reading portion 13. The ADF 12 includes a document setting portion, a plurality of conveying rollers, a document sheet holder, and a paper discharge portion.

The image reading portion 13 achieves the scanning function. The image reading portion 13 includes a document sheet table, a light source, a plurality of mirrors, an optical lens, and a CCD.

The image forming portion 14 achieves the printing function. For example, the image forming portion 14 forms an image on a sheet supplied by the sheet feed portion 15 by an electrophotographic method. For example, the image forming portion 14 includes a plurality of image forming units, a laser scanning unit, an intermediate transfer belt, a secondary transfer roller, a fixing device, and a sheet discharge tray. The image forming portion 14 may form an image on a sheet supplied by the sheet feed portion 15 by another image forming method such as an inkjet method.

The sheet feed portion 15 supplies a sheet to the image forming portion 14. The sheet feed portion 15 includes a sheet feed cassette, a manual feed tray, and a plurality of conveying rollers.

The operation display portion 16 is a user interface of the printing device 10. The operation display portion 16 has a display portion such as a liquid crystal display that displays various types of information according to a control instruction from the control portion 11, and an operation portion such as operation keys or a touch panel for inputting various information to the control portion 11 according to user operation.

The communication portion 17 is a communication interface that executes wired or wireless data communication with an external communication device such as the printing server 30 via the communication network.

The storage portion 18 is a non-volatile storage device. For example, the storage portion 18 is a storage device such as a non-volatile memory such as a flash memory, EEPROM, or the like, a Solid State Drive (SSD), a Hard Disk Drive (HDD), or the like.

The display lamp 19 is used for notifying of an operating state of the printing device 10. For example, the display lamp 19 includes a cover portion that protrudes in a columnar shape at an upper portion of the housing of the printing device 10, and three LED lamps that are arranged in the cover portion along the protruding direction of the cover portion. The three LED lamps are different colors from each other. For example, the three LED lamps include a red LED lamp, a blue LED lamp, and a green LED lamp.

[Client Terminal 20]

The client terminal 20 is a terminal device that functions as a user interface of the image forming system 100. For example, the client terminal 20 is a personal computer, a smartphone, a notebook computer, a tablet terminal, or the like.

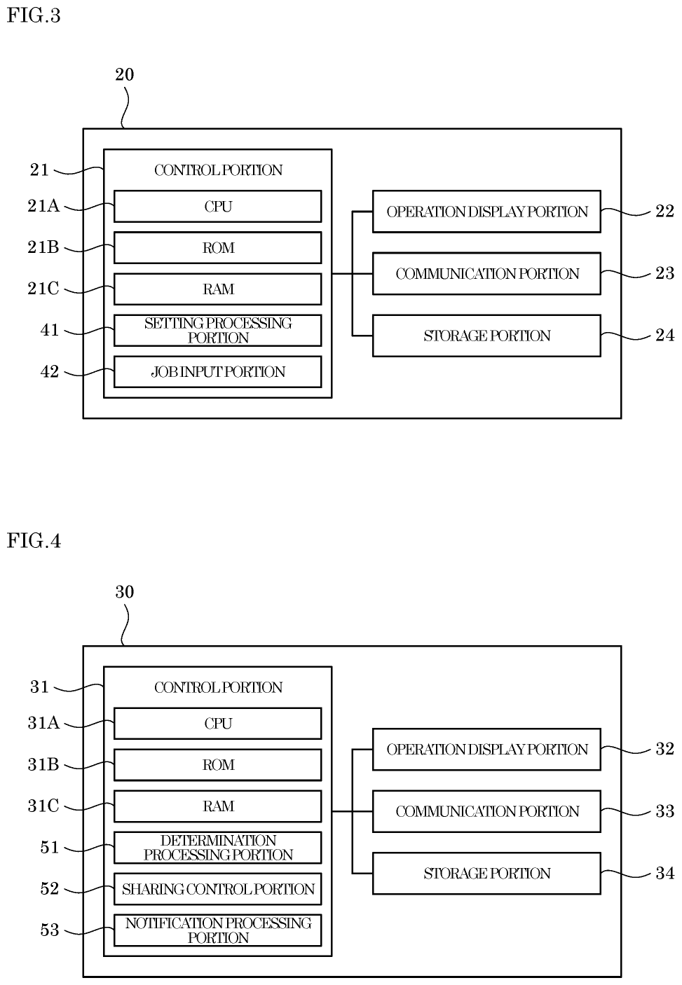

As shown in FIG. 3, the client terminal 20 includes a control portion 21, an operation display portion 22, a communication portion 23, and a storage portion 24.

The control portion 21 performs overall control of the client terminal 20. As shown in FIG. 3, the control portion 21 includes a CPU 21A, a ROM 21B, and a RAM 21C. The CPU 21A, ROM 21B, and RAM 21C have the same functions as the CPU 11A, ROM 11B, and RAM 11C of the printing device 10.

The operation display portion 22 is a user interface of the client terminal 20. The operation display portion 22 has a display portion such as a liquid crystal display that displays various types of information according to a control instruction from the control portion 21, and an operation portion such as operation keys or a touch panel for inputting various information to the control portion 21 according to user operation.

The communication portion 23 is a communication interface that executes wired or wireless data communication with an external communication device such as the printing server 30 via the communication network.

The storage portion 24 is a non-volatile storage device similar to the storage portion 18 of the printing device 10.

The storage portion 24 stores in advance client software for making the client terminal 20 function as a user interface of the image forming system 100. The CPU 21A of the control portion 21 functions as a setting processing portion 41 and a job input portion 42 shown in FIG. 3 by executing the client software.

The setting processing portion 41 sets the printing conditions of the target printing data.

For example, the setting processing portion 41 causes the operation display portion 22 to display a setting operation screen used in a setting operation for setting printing conditions in response to a predetermined user operation on the operation display portion 22. On the setting operation screen, the setting operation is received for the printing conditions such as the number of print copies of the target printing data, the printing color, and the printing layout. The setting processing portion 41 sets the printing conditions according to the setting operation received on the setting operation screen.

Here, in the image forming system 100, it is possible to share the execution of the printing job with a plurality of printing devices 10. More specifically, on the setting operation screen, the setting operation for setting whether or not to enable the execution sharing function of the printing job with a plurality of printing devices 10 is received. A user of the image forming system 100 can print the target printing data by using the execution sharing function by setting the execution sharing function to “enable” on the setting operation screen. Hereinafter, a printing job for which the execution sharing function is set to “enable” is referred to as a “specific printing job”.

The job input portion 42 inputs the printing job including the printing conditions set by the setting processing portion 41 to the printing server 30.

For example, on the setting operation screen, an execution operation for the printing job is received. In a case where the execution operation is received on the setting operation screen, the job input portion 42 inputs the printing job including the printing conditions set by the setting processing portion 41 to the printing server 30.

[Printing Server 30]

The printing server 30 is an information processing apparatus that executes the printing job input from the client terminal 20 by using one or more printing devices 10.

As shown in FIG. 4, the printing server 30 includes a control portion 31, an operation display portion 32, a communication portion 33, and a storage portion 34.

The control portion 31 performs overall control of the printing server 30. As shown in FIG. 4, the control portion 31 includes a CPU 31A, a ROM 31B, and a RAM 31C. The CPU 31A, ROM 31B, and RAM 31C have the same functions as the CPU 11A, ROM 11B, and RAM 11C of the printing device 10.

The operation display portion 32 is a user interface of the printing server 30. The operation display portion 32 has a display portion such as a liquid crystal display that displays various types of information according to a control instruction from the control portion 31, and an operation portion such as operation keys or a touch panel for inputting various information to the control portion 31 according to user operation.

The communication portion 33 is a communication interface capable of executing wired or wireless data communication with an external communication device such as a printing device 10 and a client terminal 20 via the communication network.

The storage portion 34 is a non-volatile storage device similar to the storage portion 18 of the printing device 10.

Schedule data X10 such as shown in FIG. 5 is stored in the storage portion 34. The schedule data X10 is data indicating an execution schedule for the printing jobs of each of the printing devices 10.

As shown in FIG. 5, the schedule data X10 includes device identification information, printing speed information, and operating state information corresponding to each of the printing devices 10. In addition, the schedule data X10 includes one or a plurality of items of job information corresponding to each of the printing devices 10 to which the printing job is transmitted.

The device identification information is information used for identifying the printing device 10. The printing speed information is information indicating the printing speed of the printing device 10. For example, as shown in FIG. 5, the printing speed information is information indicating the number of printed sheets per minute. The device identification information and the printing speed information are registered in the printing server 30 in advance for each printing device 10.

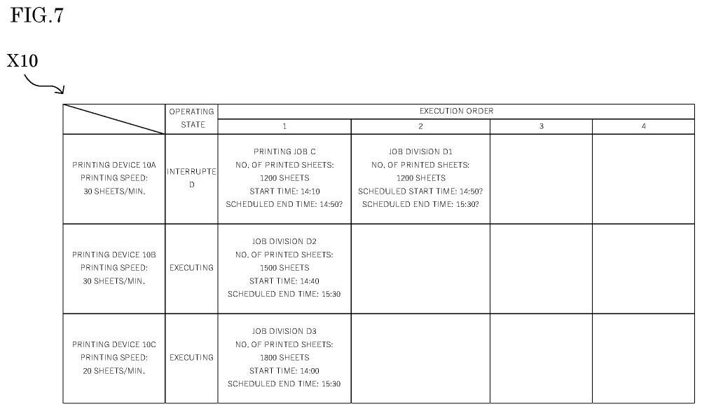

The operating state information is information indicating the operating state of the printing device 10. For example, the operating state information is information that indicates “Executing” indicating a state in which the printing job is being executed (see FIG. 5), “Sleeping” indicating a state of waiting to execute the printing job (see FIG. 5), or “Interrupted” indicating a state in which execution of the printing job is interrupted (see FIG. 7). The operating state information is updated based on information transmitted from the printing device 10.

Here, the control portion 11 of the printing device 10 controls light emission of the display lamp 19 based on the operating state of the printing device 10.

For example, in a case where the operation state of the printing device 10 is “Executing” and a printing job different from the specific printing job is being executed, the control portion 11 of the printing device 10 causes the display lamp 19 to emit light in a predetermined first light emitting mode. In addition, in a case where the operating state of the printing device 10 is “Executing” and the specific printing job is being executed, the control portion 11 causes the display lamp 19 to emit light in a second light emitting mode different from the first light emitting mode. In addition, in a case where the operating state of the printing device 10 is “Interrupted”, the control portion 11 causes the display lamp 19 to emit light in a third light emitting mode different from the first light emitting mode and the second light emitting mode. In addition, the control portion 11 does not cause the display lamp 19 to emit light when the operating state of the printing device 10 is “Sleeping”.

For example, the first light emitting mode is a light emitting mode in which only the green LED lamp is caused to emit light. In addition, the second light emitting mode is a light emitting mode in which the LED lamps of all colors are caused to emit light. In addition, the third light emitting mode is a light emitting mode in which only the red LED lamp is caused to emit light.

The job information is information related to the printing job transmitted to the printing device 10. More specifically, the job information includes job identification information, printed sheet number information, start timing information, and end timing information. The job identification information is information used for identifying the printing job. The printed sheet number information is information indicating the number of printed sheets that will be output by executing the printing job. The start timing information is information indicating a start time or a scheduled start time of the printing job. The end timing information is information indicating the scheduled end time of the printing job.

In the schedule data X10, one or more items of job information corresponding to the printing device 10 are arranged according to the execution order of the printing jobs in the printing device 10 (see FIG. 5). In a case where the printing job is transmitted to the printing device 10, the job information is generated based on the printing speed of the printing device 10, the end timing of the existing printing job in the printing device 10, and the printing conditions included in the printing job, and is incorporated in the schedule data X10. In addition, the job information is deleted at the end of the printing job corresponding to the job information.

The job information is not limited to the printing job, and may also include information related to other jobs such as a copying job executed by the printing device 10.

In a case where the printing job for which the execution sharing function is set to “Disable” is input from the client terminal 20, the control portion 31 causes any one of the printing devices 10 determined based on the schedule data X10 to execute the printing job. More specifically, the printing server 30 specifies a printing device 10 capable of finishing the input printing job earliest based on the schedule data X10, and transmits the printing job to the specified print device 10.

In addition, in a case where the specific printing job for which the execution sharing function is set to “Enable” is input from the client terminal 20, the control portion 31 causes a plurality of printing devices 10 to share the execution of the specific printing job.

Here, in the image forming system 100, in a case where each of the printing devices 10 shares the specific printing job at the same share rate, the execution timing of the shared processing of the specific printing job may be delayed in a printing device 10 that is executing an existing job, and thus the time until the specific printing job is completed may be prolonged.

On the other hand, in the image forming system 100 of this embodiment according to the present disclosure, it is possible, as will be described below, to shorten the time until the specific printing job shared by the plurality of printing devices 10 is completed.

More specifically, in the storage portion 34 of the printing server 30, a sharing control program for causing the control portion 31 to function as a determination processing portion 51, a sharing control portion 52, and a notification processing portion 53 shown in FIG. 4 is stored in advance. The CPU 31A of the control portion 31, by executing the sharing control program, functions as the determination processing portion 51, the sharing control portion 52, and the notification processing portion 53 shown in FIG. 4. The printing server 30 is an example of the image forming system according to the present disclosure. The image forming system 100 including the printing server 30 may be regarded as the image forming system according to the present disclosure.

The determination processing portion 51 determines share rates of the specific printing job for each of the printing devices 10 based on a startable timing at which a new job can be started by each of the plurality of printing devices 10. The specific printing job is an example of the image forming job according to the present disclosure.

More specifically, the determination processing portion 51 determines the share rates of the specific printing job for each of the printing devices 10 based on the startable timing and the printing speed of each of the printing devices 10.

In addition, the determination processing portion 51 determines the share rates of the specific printing job for each of the printing devices 10 so that the end timings of the shared processing by each of the printing devices 10 match.

For example, the determination processing portion 51 determines the share rates of the specific printing job for each of the printing devices 10 by the following procedure.

First, the determination processing portion 51 acquires the startable timing and the printing speed corresponding to each of the printing devices 10 from the schedule data X10.

For example, for a printing device 10 for which the operating state is set to “Executing” (see FIG. 5), the determination processing portion 51 acquires from one or a plurality of items of job information corresponding to the printing device 10, the time of the end timing information included in the job information corresponding to the printing job for which the order of execution is the latest as the startable timing. In addition, for a printing device 10 for which the operating state is set to “Sleeping” (see FIG. 5), the determination processing portion 51 acquires the current time as the startable timing. For the printing devices 10 (see FIG. 7) for which the operating state is set to “Interrupt”, the end timing of an existing job is uncertain, and thus the determination processing portion 51 does not acquire the startable timing, and determines the share rate for the specific printing job to be “0%”.

Next, the determination processing portion 51 determines the printing devices 10 to be in charge of executing the specific printing job based on the acquired startable timing and the printing speed corresponding to each of the printing devices 10.

For example, the determination processing portion 51 determines that all of the plurality of printing devices 10 are candidates to be in charge of executing the specific printing job. The determination processing portion 51 repeatedly executes the following exclusion process until the printing devices 10 to be in charge of executing the specific printing job are determined. More specifically, in the exclusion process, it is determined whether or not the specific printing job will be completed by the startable timing of the printing device 10 having the latest startable timing in a case where the specific printing job is shared and executed by the remaining printing devices 10 after excluding the printing device 10 having the latest startable timing from among the current candidates to be in charge of executing the specific printing job. In a case where it is determined that the specific printing job will be completed, the printing device 10 having the latest startable timing is excluded from the candidates to be in charge of executing the specific printing job. On the other hand, in a case where it is determined that the specific printing job will not be completed, the current candidates to be in charge of executing the specific printing job are determined as the printing devices 10 to be in charge of executing the specific printing job.

Next, the determination processing portion 51, based on the acquired startable timing and printing speed corresponding to each of the printing devices 10, acquires a specific timing at which the total number of sheets that can be output from the startable timing by each of the printing devices 10 determined to be in charge of executing the specific printing job will reach the number of printed sheets of the specific printing job.

The determination processing portion 51, based on the acquired startable timing and printing speed corresponding to each of the printing devices 10, and the acquired specific timing, determines the share rates of the specific printing job for each of the printing devices 10 determined to be in charge of executing the specific printing job. The determination processing portion 51 determines the share rate of the specific printing job for each of the printing devices 10 excluded from being candidates in charge of executing the specific printing job to be “0%”.

The determination processing portion 51 may determine the share rates of the specific printing job for each of the printing devices 10 so that the end timings of the shared processing by each of the printing devices 10 arrive in sequence. For example, the share rates of the specific printing job for each of the printing devices 10 may be determined so that the end timings of the shared processing by each of the printing devices 10 arrive sequentially at intervals set based on the positional relationship of the plurality of printing devices 10. For example, first, the end timing of the shared processing by the printing device 10A (see FIG. 1) may arrive, next, the end timing of the shared processing by the printing device 10B (see FIG. 1) may arrive after a first interval, and finally, the end timing of the shared processing by the printing device 10C (see FIG. 1) may arrive after a second interval. The first interval is set based on the separation distance between the printing device 10A and the printing device 10B. The second interval is set based on the separation distance between the printing device 10B and the printing device 10C.

In addition, the determination processing portion 51 may determine the share rates of the specific printing job for each of the printing devices 10 so that the later the arrival of the startable timing is, the smaller the share rate of the specific printing job is. For example, the determination processing portion 51 may determine the share rates of the specific printing job for each of the printing devices 10 so that the share rates of the specific printing job decrease by a predetermined value each time the arrival order of the startable timing is lowered.

The sharing control portion 52 causes the plurality of printing devices 10 to share the specific printing job based on the share rates of the specific printing job determined by the determination processing portion 51.

For example, the sharing control portion 52 divides the specific printing job based on the share rates of the specific printing job for each of the printing devices 10 determined by the determination processing portion 51. The sharing control portion 52 transmits each of the job divisions acquired by dividing the specific printing job to the printing devices 10 corresponding to the job divisions, and causes the printing devices 10 to execute the job divisions.

In addition, the sharing control portion 52 updates the schedule data X10 in a case where a plurality of printing devices 10 share the specific printing job. More specifically, the sharing control portion 52 generates the job information corresponding to each of the job divisions, and incorporates each item of the generated job information into the schedule data X10.

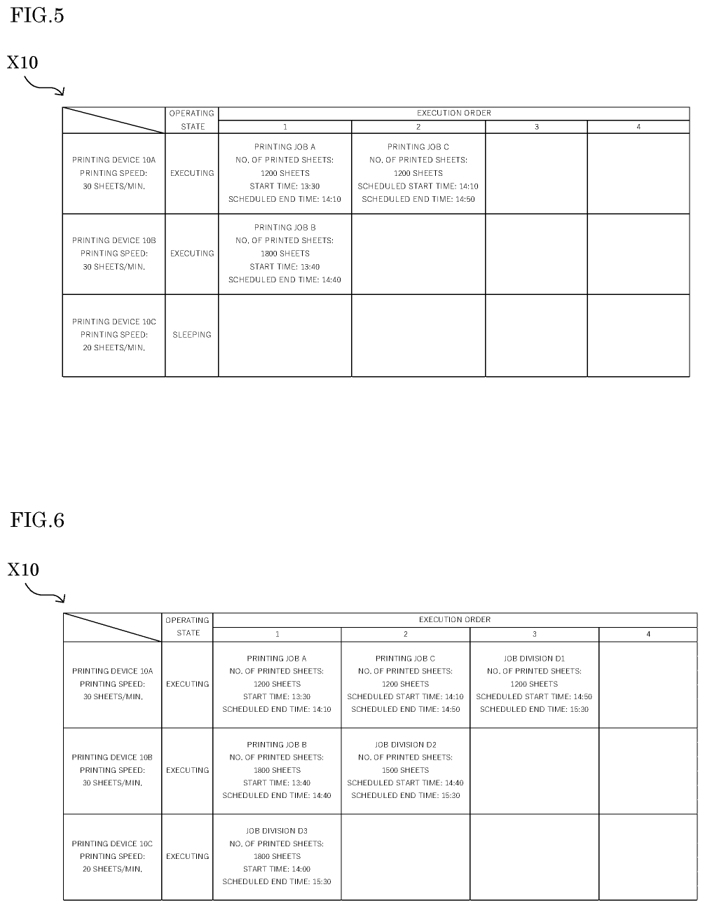

FIG. 6 shows an example of updating the schedule data X10 by the sharing control portion 52. FIG. 6 shows a state in which the schedule data X10 shown in FIG. 5 was updated by the sharing control portion 52. In addition, FIG. 6 shows an example of updating the schedule data X10 in a case where at 14:00, a specific printing job D having 4500 sheets is input, and the specific printing job D is divided into a job division D1 with 1200 sheets, a job division D2 with 1500 sheets, and a job division D3 with 1800 sheets.

In addition, in a case where execution of a job is interrupted in any one of the printing devices 10 that share the specific printing job, the sharing control portion 52 causes a plurality of printing devices 10 to share the unprocessed portion of the shared portion of the specific printing job corresponding to the printing device 10. The job may be the job division or a job different from the job division.

For example, the determination processing portion 51 causes second printing devices that are different from a first printing device in which execution of the job was interrupted to share the unprocessed portion. For example, the determination processing portion 51 determines share rates of the unprocessed portion for each of the second printing devices based on the startable timing and the printing speed of each of the second printing devices at the timing when the execution of the job is interrupted. In addition, the determination processing portion 51 determines the share rates of the unprocessed portions for each of the second printing devices so that the end timings of processing the unprocessed portion by each of the second printing devices match.

The sharing control portion 52 causes one or more of the second printing devices to share the execution of the unprocessed portion based on the share rates of the unprocessed portion determined by the determination processing portion 51.

For example, after the specific printing job D is divided into the job division D1 (see FIG. 6), the job division D2 (see FIG. 6), and the job division D3 (see FIG. 6) by the sharing control portion 52, it is presumed that at 14:45 the execution of the printing job C is interrupted due to an error of the printing device 10A running out of paper (see FIG. 7).

In this case, the unprocessed portion is job division D1, and the determination processing portion 51 determines the share rates of the unprocessed portion for each of the second printing devices based the startable timing and the printing speed of each of the second printing devices at the timing at which execution of printing job C is interrupted. More specifically, the determination processing portion 51 determines the share rate for printing device 10B to be “60%” and determines the share rate for printing device 10C to be “40%”.

The sharing control portion 52 may cause the first printing device and the second printing devices to share the unprocessed portion. For example, the determination processing portion 51 may determine the share rates of the unprocessed portion for each of the printing devices 10 so that the share rates of the unprocessed portion for each of the printing devices 10 are equal.

The notification processing portion 53 notifies of the plurality of printing devices 10 that share the specific printing job and the end timing of the specific printing job.

For example, the notification processing portion 53, causes the operation display portion 22 of the client terminal 20 to display a message notifying of the device identification information of each of the plurality of printing devices 10 that share the specific printing job, the share rates of the specific printing job, and the end timing of the shared processing. The notification processing portion 53 may cause the schedule data X10 to be displayed on the operation display portion 22 of the client terminal 20.

In addition, in a case where execution of a job was interrupted in any one of the printing devices 10 that share the specific printing job, the notification processing portion 53 notifies of such.

For example, the notification processing portion 53 causes the operation display portion 22 of the client terminal 20 to display a message indicating that execution of a job has been interrupted in a printing device 10 that shares the specific printing job and includes the device identification information of the printing device 10 in which execution of the job was interrupted, and the cause of the interruption. In addition, the notification processing portion 53 causes the operation display portion 22 of the client terminal 20 to display a message notifying of the share rates of the unprocessed portion for each of the second printing devices, and the end timing of processing of the unprocessed portion.

[Sharing Control Process]

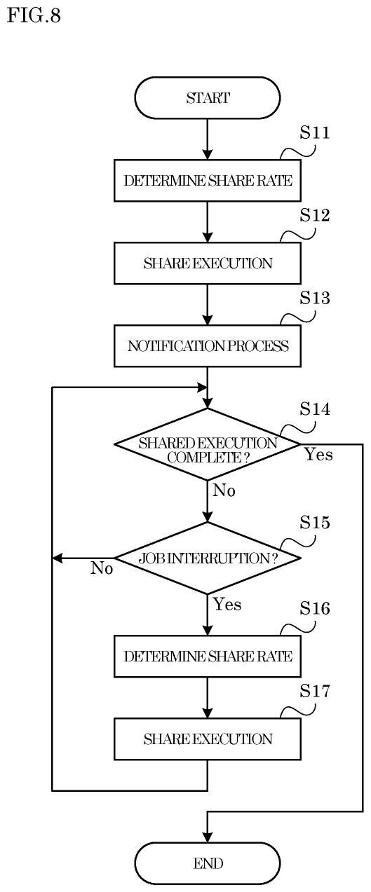

Hereinafter, with reference to FIG. 8, the image forming method according to the present disclosure will be described together with an example of the procedure of the sharing control process executed by the control portion 31 of the printing server 30 in the image forming system 100. Here, steps S11, S12, and so on represent the number of the processing procedure (step) executed by the control portion 31. The sharing control process is executed in a case where a specific printing job is input to the printing server 30.

<Step S11>

First, in step S11, the control portion 31 determines the share rates of the specific printing job for each of the printing devices 10. Here, the processing in step S11 is an example of a determination step according to the present disclosure, and is executed by the determination processing portion 51 of the control portion 31.

More specifically, the control portion 31 acquires the startable timing and the printing speed corresponding to each of the printing devices 10 from the schedule data X10. In addition, the control portion 31 determines the printing devices 10 to be in charge of executing the specific printing job based on the acquired startable timing and the printing speed corresponding to each of the printing devices 10. In addition, the control portion 31 acquires the specific timing based on the acquired startable timing and the printing speed corresponding to each of the printing devices 10. The control portion 31, based on the acquired startable timing and printing speed corresponding to each of the printing devices 10, and the acquired specific timing, determines the share rates of the specific printing job for each of the printing devices 10 determined to be in charge of executing the specific printing job. In addition, the control portion 31 determines the share rates of the specific printing job for each of the printing devices 10 excluded from being a candidate in charge of executing the specific printing job to be “0%”.

<Step S12>

In step S12, the control portion 31 causes a plurality of printing devices 10 to share the execution of the specific printing job based on the share rates of the specific printing job determined in step S11. Here, the processing in step S12 is an example of a sharing control step according to the present disclosure, and is executed by the sharing control portion 52 of the control portion 31.

More specifically, the sharing control portion 31 divides the specific printing job based on the share rates of the specific printing job for each of the printing devices 10 determined in step S11. The control portion 31 transmits each of the job divisions acquired by dividing the specific printing job to the printing devices 10 corresponding to the job divisions, and causes the printing devices 10 to execute the job divisions.

In addition, the control portion 31 updates the schedule data X10. More specifically, the control portion 31 generates the job information corresponding to each of the job divisions, and incorporates each item of the generated job information into the schedule data X10.

<Step S13>

In step S13, the control portion 31 executes a notification process for notifying of the plurality of printing devices 10 that share the specific printing job and the end timing of the specific printing job. Here, the processing of step S13 is executed by the notification processing portion 53 of the control portion 31.

For example, the control portion 31 causes the operation display portion 22 of the client terminal 20 to display a message notifying of the device identification information of each of the plurality of printing devices 10 that share the specific printing job, the share rates of the specific printing job, and the end timing of the shared processing.

<Step S14>

In step S14, the control portion 31 determines whether or not shared execution of the specific printing job by the plurality of printing devices 10 is completed.

Here, when the control portion 31 determines that shared execution of the specific printing job by the plurality of printing devices 10 is completed (S14: Yes), the control portion 31 ends the sharing control process. In addition, when shared execution of the specific printing job is not completed (S14: No), the control portion 31 moves the process to step S15.

<Step S15>

In step S15, the control portion 31 determines whether or not execution of a job is interrupted in any one of the printing devices 10 that share the execution of the specific printing job.

Here, when the control portion 31 determines that the execution of a job is interrupted in any one of the printing devices 10 that share the execution of the specific printing job (S15: Yes), the control portion 31 moves the process to step S16. In addition, when a job is not interrupted (S15: No), the control portion 31 moves the process to step S14.

In a case where the control portion 31 determines that the execution of a job is interrupted in any one of the printing devices 10 that share the execution of the specific printing job, the control portion 31 notifies the user of the image forming system 100 of such and updates the schedule data X10.

<Step S16>

In step S16, the control portion 31 determines the share rates of the unprocessed portion for each of the second printing devices based on the startable timing and the printing speed of each of the second printing devices at the timing when the execution of the job is interrupted. Here, the processing of step S16 is executed by the determination processing portion 51 of the control portion 31.

<Step S17>

In step S17, the control portion 31 causes one or more of the second printing devices to share the unprocessed portion based on the share rates of the unprocessed portion determined in step S16. Here, the processing of step S17 is executed by the sharing control portion 52 of the control portion 31.

In a case where the control portion 31 executes the processing of step S17, the control portion 31 notifies the user of the image forming system 100 of the share rates of the unprocessed portion for each of the second printing devices determined in step S16 and the end timing of the processing of the unprocessed portion, and updates the schedule data X10.

In this way, in the image forming system 100, the share rates of the specific printing job for each of the printing devices 10 is determined based on the startable timing at which a new job can be started by each of the printing devices 10. The specific printing job is shared by the plurality of printing devices 10 based on the determined share rates. Thus, it is possible to shorten the time until the specific printing job is completed as compared with a configuration in which each of the printing devices 10 shares the specific printing job at the same share rate.

In addition, in the image forming system 100, the share rates of the specific printing job for each of the printing devices 10 is determined based on the startable timing and the printing speed of each of the printing devices 10. Thus, it is possible to determine the share rates of the specific printing job for each of the printing devices 10 so that the end timing of the shared processing in each of the printing devices 10 becomes an arbitrary timing. For example, in a case where the share rates of the specific printing job for each of the printing devices 10 are determined so that the end timings of the shared processing by each of the printing devices 10 match, the time until the specific printing job is completed can be optimally shortened.

In addition, in the image forming system 100, in a case where the execution of a job is interrupted in any one of the printing devices 10 that share the specific printing job, the unprocessed portion of the shared portion corresponding to that printing device 10 is shared by a plurality of printing devices 10. Thus, in a case where the shared processing or a job that is executed before the shared processing is interrupted, it is possible to prevent the time until the specific printing job is completed from becoming long.

In the image forming system 100, any one of the printing devices 10 may include the function of the printing server 30. More specifically, any one of the printing devices 10 may include the determination processing portion 51, the sharing control portion 52, and the notification processing portion 53. In this case, the image forming system 100 does not have to include the printing server 30 separately from the printing device 10.

In addition, in the image forming system 100, the printing server 30 may include the function of the client terminal 20. More specifically, the printing server 30 may include the setting processing portion 41 and the job input portion 42. In this case, the image forming system 100 does not have to include the client terminal 20 separately from the printing server 30.

In addition, in the image forming system 100, any one of the printing devices 10 may include the functions of the printing server 30 and the client terminal 20. More specifically, any one of the printing devices 10 may include the setting processing portion 41, the job input portion 42, the determination processing portion 51, the sharing control portion 52, and the notification processing portion 53. In this case, the image forming system 100 does not have to include the client terminal 20 and printing server 30 separately from the printing device 10.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming system, comprising:
a determination processing portion configured to determine share rates of an image forming job for each of a plurality of image forming apparatuses based on a startable timing at which a new job can be started by each of the plurality of image forming apparatuses; and
a sharing control portion configured to cause the plurality of image forming apparatuses to share the image forming job based on the share rates of the image forming job determined by the determination processing portion.

2. The image forming system according to claim 1, wherein
the determination processing portion determines the share rates of the image forming job for each of the image forming apparatuses based on the startable timing and a printing speed of each of the image forming apparatuses.

3. The image forming system according to claim 1, wherein
the determination processing portion determines the share rates of the image forming job for each of the image forming apparatuses so that end timings of shared processing of the image forming job by each of the image forming apparatuses match.

4. The image forming system according to claim 1, wherein
the sharing control portion, in a case where execution of a job is interrupted in any one of the image forming apparatuses that share the image forming job, causes a plurality of the image forming apparatuses to share an unprocessed portion of a shared portion of the image forming job corresponding to the image forming apparatus.

5. The image forming system according to claim 1, further comprising
a notification processing portion configured to notify of the plurality of image forming apparatuses that share the image forming job and the end timing of the image forming job.

6. An image forming method executed by an image forming system, comprising:
a determination step of determining share rates of an image forming job for each of a plurality of image forming apparatuses based on a startable timing at which a new job can be started by each of the plurality of image forming apparatuses; and
a sharing control step of causing the plurality of the image forming apparatuses to share the image forming job based on the share rates of the image forming job determined in the determination step.
